(19) United States
(12) Patent Application Publication
(10) Pub. No.: US 2006/0178270 A1
(43) Pub. Date: Aug. 10, 2006

(54) Method for the potentiation and stimulation of natural plant defences

(76) Inventors: Yann Chevolot, Carantec (FR); Olivier Klarzynski, Plouvorn (FR); Jean-Claude Yvin, Saint-Malo (FR); Bernard Kloareg, Plouenan (FR)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 10/549,212

(22) PCT Filed: Mar. 1, 2004
(86) PCT No.: PCT/FR04/00468

§ 371 Date: Sep. 14, 2005

(30) Foreign Application Priority Data
Mar. 14, 2003 (FR) 03/03172

(51) Int. Cl. A01N 43/02; A01N 43/04

(52) U.S. Cl. 504/291; 514/54

(57) ABSTRACT

The invention relates to the use of xanthan oligomers, preferably with a degree of polymerisation of between 1 and 30, in methods for the stimulation of the natural defences of plants, e.g. monocotyledones and, in particular, cereals or, more specifically, wheat and dicotyledones of, for example, vines, tobacco, potatoes and tomatoes.

The invention relates to a method for the potentiation and stimulation of natural plant defenses, especially the natural defenses of monocotyledons, and in particular cereals, including more particularly wheat, and of dicotyledons, especially vines, tobacco, potatoes and tomatoes.

The stimulation of natural plant defenses remains one of the most current problems and is always the subject of numerous research studies.

It is known that the incubation of plants in the presence of substances known as elicitors stimulates defense reactions of the type:
accumulation of natural antibiotics more commonly known as phytoalexins,
synthesis of defense proteins such as chitinases or glucanases, also known as PRPs (pathogenesis-related proteins),
hardening of cell walls through the synthesis of lignin or of crosslinking proteins,
synthesis of secondary messengers such as ethylene, hydrogen peroxide or salicylic acid.

Among these elicitors, mention may in particular be made of oligopectins; they elicit, in various agronomic plants, the abovementioned defense reactions; maximum responses are generally reached for concentrations of the order of 100 mg/l and they are maintained at a comparable level up to concentrations of 4 g/l.

In this regard and by way of example, the production and accumulation of phytoalexins, in the case in point avenalumin-1 in oats, has been obtained, according to published Japanese patent application No. HEI 3-339080 of Dec. 20, 1991, by the company K.K. Fushimi Seiyakusho, by using, on pieces of oat leaves, aqueous solutions containing pectin oligomers having a DP 6, DP 8, DP 10 and DP 12, at concentrations of 100 to 1000 mg/l.

In the context of its research studies aimed at enriching the arsenal of substances that can be used as elicitors in methods for the stimulation of natural plant defenses, especially for the natural defenses of monocotyledons, and in particular of cereals, including more particularly wheat, and of dicotyledons, especially of vines, tobacco, potatoes and tomatoes, the applicant company has to its credit found that xanthan oligomers satisfy this aim.

A subject of the invention is therefore, according to a first aspect, the use of xanthan oligomers as elicitors in methods for the stimulation of natural plant defenses, especially the natural defenses of monocotyledons, and in particular of cereals, including more particularly wheat, and of dicotyledons, especially vines, tobacco, potatoes and tomatoes.

The subject of the invention is also a method for the stimulation of natural plant defenses, in particular the natural defenses of dicotyledons, and especially tobacco and tomatoes, characterized in that an effective amount of at least one xanthan oligomer, especially in the form of a composition, and more particularly of an aqueous solution whose concentration of at least one xanthan oligomer is from 50 mg/l to 5000 mg/l, preferably from 50 mg/l to 1000 mg/l, is applied especially to the leaves or to the seeds or grains, the effective amount corresponding to the amount of xanthan oligomer(s) that is provided to the plants to be treated by applying the above mentioned aqueous solution in a proportion of 10 g to 1000 g, preferably of 20 g to 500 g, per hectare of crop.

According to this first aspect, the invention therefore makes it possible to assist the plant in particular at the moment when it is the subject of an attack by a pathogenic agent or at the moment when such an attack appears to be imminent, by then stimulating its natural defenses by virtue of the use of the xanthan oligomers, this stimulation resulting especially in an accumulation, in its tissues, in particular of phytoalexins and of PR proteins (pathogenesis-related proteins).

However, frequently, there is no immediate fear of such an attack.

Moreover, in this case, the stimulation of natural plant defenses by implementing the method in accordance with the invention represents, for said plant, a not insignificant expenditure of energy, useless as long as the attack does not occur.

Now, while it is entirely possible to monitor crops with a view to detecting the moment at which there is a risk of an attack by a pathogenic agent occurring, and at which the implementation of the method in accordance with the invention becomes necessary, such monitoring is tedious and expensive.

And it is a further applicant company's credit to have found that, according to a second aspect of the invention, it is possible to manage this situation by applying to the plant, and especially to the leaves or seeds or grains, in the absence of any pathogenic agent, an aqueous solution of at least one xanthan oligomer in which the concentration of the xanthan oligomer is less than the lower limit of the concentration range applicable in the context of the first aspect of the invention, the effective amount, i.e. the amount of at least one xanthan oligomer that has to be provided to the plant, being itself also less than the lower limit of the range selected in the context of the first aspect of the invention, by virtue of which no notable elicitation occurs at the moment the method in accordance with the invention is implemented, whereas, at the moment when the plant is attacked by a pathogenic agent, a potentiated stimulation of the plant's natural defenses occurs completely unexpectedly and surprisingly, thereby resulting in immunization of the treated plant.

It ensues that a subject of the invention is also a method for the stimulation and potentiation of natural plant defenses, especially the natural defenses of monocotyledons, and in particular of cereals, including more particularly wheat, and of dicotyledons, especially of vines, tobacco, potatoes and tomatoes, characterized in that an effective amount of at least one xanthan oligomer, especially in the form of a composition, and in particular of an aqueous solution containing the xanthan oligomer(s) at a concentration of 0.1 mg/l to 50 mg/l, preferably of 0.5 mg/l to 20 mg/l, is applied especially to the leaves or to the seeds or grains and before any attack by a pathogenic agent, the effective amount corresponding to that which is provided to the plants to be treated by applying the abovementioned composition in a proportion of 50 l to 1000 l, preferably of 200 l to 500 l, per hectare of crop.

The applicant company has in fact been able to note that, when, according to the second aspect of the invention, the xanthan oligomers are used in the form of aqueous solutions in which they are present at concentrations in the narrow range of from 0.1 to 50 mg/l, they exert on the treated plants a natural defense-potentiating effect that is triggered only from the moment when the attack by a pathogenic agent effectively occurs.

The advantage of this second aspect of the invention is that the plant's metabolism is not diverted to the setting up of defense reactions at a time when this setting up is pointless; on the other hand, this metabolism is placed on alert and, when the plant is subject to an attack, it mobilizes its natural defenses, much more intensely than in the absence of the treatment in accordance with the method according to the invention.

The xanthan oligomers used in accordance with the invention have a degree of polymerization of preferably 1 (5 saccharide units) to 30 (150 saccharide units).

The compositions and in particular the aqueous solutions applied to the plants treated in the context of the methods in accordance with the first and with the second aspect of the invention may contain only a single xanthan oligomer having a degree of polymerization of preferably 1 to 30, or a mixture of several of these oligomers.

These xanthan oligomers are the result of the degradation, in particular enzymatic degradation, of xanthan, which is an exo- or heteropolysaccharide extracted from bacteria of the Xanthomonas genus.

Xanthan is used in the agrofoods industry, especially as a texturant agent, stabilizer/emulsifier or dispersing agent.

It corresponds to the general formula 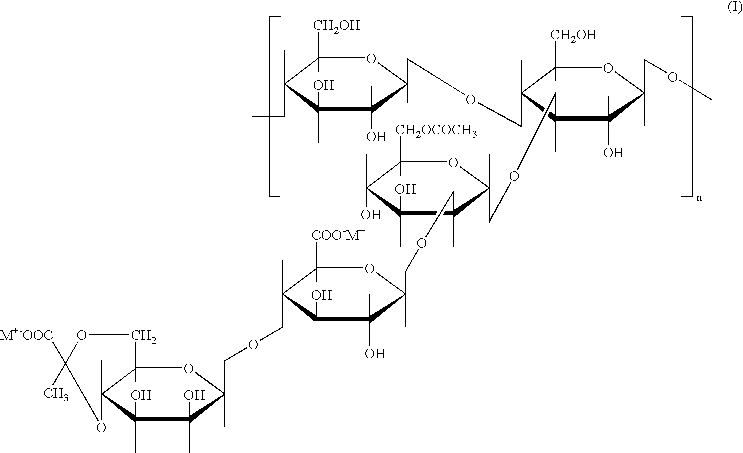
in which
n is an integer,
M⁺ represents the ions Na, K or 1/2 Ca.

The molecular weight of xanthan is from 2×10⁶ to 20×10⁶ Da.

It consists essentially of a chain of glucose units linked to one another via β-1,4 linkages, one glucose unit out of approximately two bearing a trisaccharide side chain.

The trisaccharide side chain is linked to the carbon 3 of the glucose of the main chain; it consists of α-D-mannose-(1,4)-β-D-glucuronic acid-(1,2)-β-D-mannose.

The first mannose unit of the side chain can be substituted with an acetate in the 6 position and the end mannose unit can be substituted with a pyruvate in the 4- and 6-positions.

The degrees of acetylation and of pyruvation and also the degree of branching depend on the starting strain and on the culturing conditions.

The behavior in solution of xanthan depends on its degree of organization. This behavior also depends on the concentration of polymers, on the ionic strength of the solution and on the temperature of dissolution and, when xanthan is dissolved in its disordered form, i.e. dissolved under hot conditions and without salts, it can be hydrolyzed by cellulases (Rinaudo et al., Int. J. Biol. Macromol. 1980; F. Garcia Ochoa et al., Biotechnology advances, 2000).

In practice, the applicant company has effectively carried out an enzymatic hydrolysis of a solution of disordered xanthan.

The starting xanthan may be that sold by the company Degussa and obtained from Xanthomonas campestris by dialysis against deionized water (Satiaxane CX90, batch 2001 4317).

The enzymes used can be cellulases, for example
that sold under the trade mark Celluclast, this enzyme being used after desalination of the xanthan on biogel P2 (YCII 31),
that sold under the name Worthington 2609/50k4255, also used after desalination of the xanthan by ultrafiltration at 10000 Da through an EPS membrane (YCII 39).

The enzymatic degradation was carried out in a water bath at 55° C.

500 mg of desalinated xanthan were dissolved under hot conditions, i.e. at a temperature of greater than 80° C., in 500 ml of deionized water.

The ph measured was 4.7.

The solution was brought to 55° C., and then 300 μl of Celluclast were added.

After two hours, since no significant hydrolysis was observed by size exclusion chromatography (carried out on Superdex 30 gel), 2 ml of Worthington cellulase were then added and the hydrolysis was continued at 55° C. for 24 hours.

The solution was then filtered through a 10 000 Da membrane (Polyether sulfone, pressure 40 psi).

The retentate was diafiltered with 90 ml of deionized water and the two filtrates were combined.

Total weight of filtrate: 220 mg which corresponds to a yield of 44%.

Weight of retentate: 118 mg.

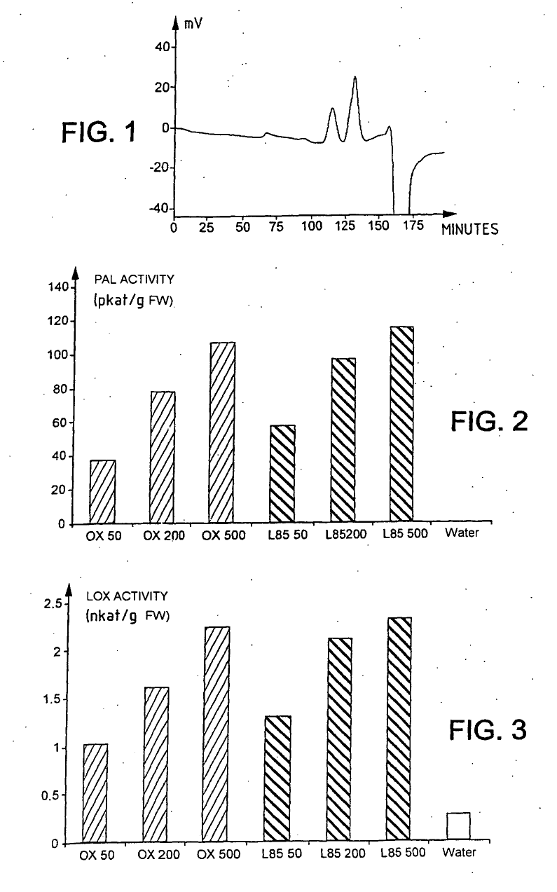

The hydrolysate thus obtained, in other words the filtrate that has just been discussed, was examined by size exclusion chromatography, which gave the spectrum in FIG. 1, which shows the variation in potential expressed in mV (refractive index detector) as a function of time expressed in minutes.

The spectrum in question comprises, as is visible, two main peaks at 115 and 132 minutes which could correspond respectively to the decasaccharide (dimer) and to the pentasaccharide (monomer).

Examination of the filtrate by high performance liquid chromatography (HPLC) reveals a more complex fine structure showing many peaks, certainly related to different degrees of pyruvation and/or of acetylation.

Finally, analysis of the structure by NMR confirms the presence of pyruvate and of acetate. After total hydrolysis, the percentage by mass of neutral saccharides in the oligomers (50%) and also the fact that the HPLC profiles of the total hydrolysates are similar to those of the starting polymer confirm that these are products of the same chemical nature (but with different degrees of polymerization).

In view of these various examinations, the xanthan hydrolysate thus obtained, hereinafter referred to as HX, is a mixture of xanthan oligomers that can be represented by FIG. 1, in which n is less than 30, in particular less than 10.

It is this hydrolysate, in other words the mixture of oligomers making up the filtrate, which, initially, was studied from the point of view of its possible influence on natural plant defense mechanisms.

It was used in the form of aqueous solutions at various concentrations of hydrolysate.

By way of comparison, plant cells originating from the same plants were treated, under the same conditions, firstly with aqueous solutions containing, at the same concentrations, a well known elicitor, i.e. laminarin, and secondly with an inactive control, i.e. water.

The laminarin tested by way of comparison is a β 1-3 glucan having degrees of polymerization of 25 to 30, extracted from brown algae.

More particularly, the direct elicitor effect of the hydrolysate in question was studied by applying, to cell cultures or cell suspensions of BY tobacco and of tomatoes of the MSK8 variety, aqueous solutions containing increasing concentrations of hydrolysate HX, and then of laminarin, these concentrations being respectively equal to 50 mg/l, 200 mg/l and 500 mg/l.

For each concentration, both of the hydrolysate used in accordance with the invention and of the laminarin, two markers of defense reactions were tested, i.e.:
phenylalanine ammonia lyase (PAL) activity, which is a key enzyme for the generation of salicylic acid, i.e. of an element of the signaling cascade that results in the activation of defense genes, and for the synthesis of phytoalexins in plants, and
lipoxygenase (LOX) activity, which is an enzyme involved in the generation of methyl jasmonate, i.e. of an element of the signaling cascade that results in defense gene activity.

The three solutions studied, based on the hydrolysate HX used in accordance with the invention, are denoted by
OX₅₀: solution containing 50 mg of hydrolysate per liter,
OX₂₀₀: solution containing 200 mg of hydrolysate per liter,
OX₅₀₀: solution containing 500 mg of hydrolysate per liter,

OX being the abbreviation selected to denote the hydrolysate HX.

The three aqueous solutions for comparison, based on laminarin, are denoted by
L85₅₀: solution containing 50 mg of laminarin per liter,
L85₂₀₀: solution containing 200 mg of laminarin per liter,
L85₅₀₀: solution containing 500 mg of laminarin per liter.

The PAL activity is measured 6 hours after the beginning of treatment and the LOX activity is measured 18 hours after the beginning of treatment, firstly with the hydrolysate solutions, secondly again with the laminarin solutions and with water, the PAL and LOX activities revealed and expressed respectively in picokatal per gram of fresh weight (pkat/g FW) in the case of the PAL activity and in nanokatal per gram of fresh weight (nkat/g FW) in the case of the LOX activity.

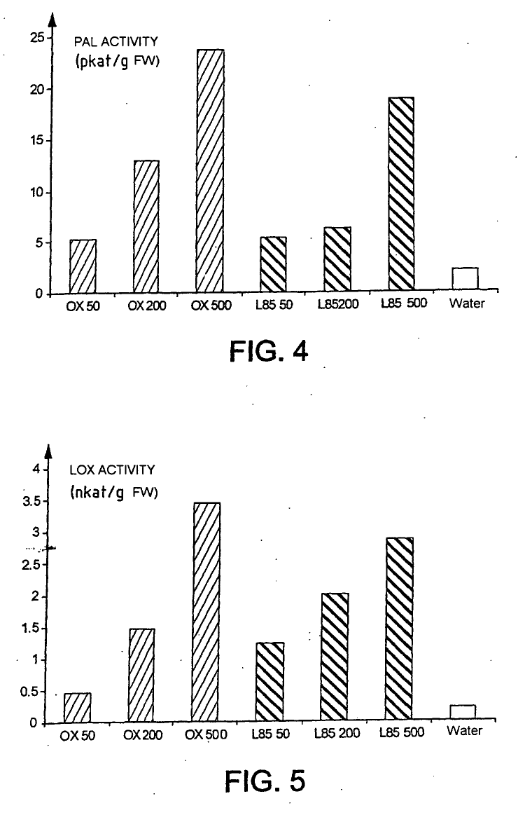

These results are recorded on the diagrams
of FIG. 2 as far as the assay of PAL activity in the case of tobacco is concerned,
of FIG. 3 as far as the assay of LOX activity in the case of tobacco is concerned,
of FIG. 4 as far as the assay of PAL activity in the case of tomato is concerned,
of FIG. 5 as far as the assay of LOX activity in the case of tomato is concerned.

Examination of the diagrams in FIGS. 2 to 5 shows
that, in the case of tobacco, the stimulation of PAL activity is, overall, similar for the hydrolysate HX used in accordance with the invention and for laminarin, the stimulations of LOX activity also being very similar to one another for the two products,
that, in the case of tomato, the hydrolysate HX used in accordance with the invention is found to be slightly more effective than laminarin in the case of the stimulation of PAL activity, whereas, in the case of the stimulation of LOX activity, the two products are very similar to one another.

It is therefore possible to conclude that the xanthan oligomers used in accordance with the invention are effective elicitors of PAL and LOX activities in plants, especially in the case of dicotyledons, and more particularly in the case of tobacco and tomatoes.

In practice, the plants whose natural defenses are to be stimulated are treated either during an attack by a pathogenic agent or with a view to a future attack, using a composition, in particular an aqueous solution, which should be applied to the leaves or to the seeds and which comprises, besides the conventional carriers and constituents of this type of composition, one or more xanthan oligomers as defined above, present at the concentrations also indicated above and which depend on the desired result, i.e. immediate stimulation or potentiation of defenses.

The treatment is generally carried out from the first vegetative stages of the plant, optionally by several successive applications, advantageously by spraying.

The precise moment of the application(s) will be chosen in particular according to the plant treated.

The carrier or vector is generally water.

It is, however, possible to make use, instead and in place of water, of a vector chosen from the group comprising mineral oils, plant oils, any liquid fatty substances, and alcohols, including in particular propylene glycol or glycerol.

The essential conventional constituents of the abovementioned compositions can vary according to the nature of the plant treated; they are generally chosen from the group comprising solvents, surfactants, dispersing agents and/or solid fillers.

By way of nonlimiting examples, the constituents of a xanthan oligomer-based liquid concentrate and of a xanthan oligomer-based soluble powdered concentrate, used in accordance with the invention, are given hereinafter.

1. Xanthan Oligomer-Based Liquid Concentrate for Agriculture:

| | | |
|---|---|---|
| Mixture of HX xanthan oligomers | 0.1 | kg |
| Tween 80 | 0.2 | kg |
| Methyl paraben, sodium salt | 0.001 | kg |
| Water | qs 1 | kg |
| Total | 1000 | kg |

This liquid concentrate is used after dilution of an amount of preferably between 500 and 50 000 g, preferably between 500 and 10 000 g, in 1000 liters of water.

This dilution provides a composition having an HX xanthan oligomer content of between 50 and 5000 g, preferably between 50 and 1000 g, per 1000 liters of water.

2. Soluble Powdered Concentrate Containing the HX Hydrolysate, as Active Material

Per 1 kg by weight/weight, the constitution of this powder is as follows:

| | |
|---|---|
| HX hydrolysate | 0.15 kg |
| Kaolin | 0.5 kg |
| Mannose | 0.05 kg |
| Methyl paraben, sodium salt | 0.005 kg |
| Purified starch | 0.295 kg |
| Total | 1000 kg |

This powdered concentrate is used after dilution in a sufficient amount of water to obtain a composition having an HX hydrolysate content of between 50 and 5000 g per 1000 liters of water, preferably between 50 and 1000 g.

1. The use of xanthan oligomers preferably having a degree of polymerization of 1 to 30, in methods for the stimulation of natural plant defenses, especially the natural defenses of monocotyledons, and in particular of cereals, including more particularly wheat, and of dicotyledons, especially vines, tobacco, potatoes and tomatoes.

2. A method for the stimulation of natural plant defenses, especially the natural defenses of monocotyledons, and in particular of cereals, including more particularly wheat, and of dicotyledons, especially vines, tobacco and tomatoes, characterized in that an effective amount of at least one xanthan oligomer having a degree of polymerization of 1 to 30, especially in the form of a composition, and more particularly of an aqueous solution, whose concentration of at least one xanthan oligomer is from 50 mg/l to 5000 mg/l, preferably from 50 mg/l to 1000 mg/l, is applied especially to the leaves or to the seeds or grains, the effective amount corresponding to the amount of xanthan oligomer(s) that is provided to the plants to be treated by applying the abovementioned aqueous solution in a proportion of 10 g to 1000 g, preferably of 20 g to 500 g, per hectare of crop.

3. Use of xanthan oligomers preferably having a degree of polymerization of 1 to 30, in methods for the stimulation and potentiation of natural plant defenses, especially the natural defenses of monocotyledons, and in particular of cereals, including more particularly wheat, and of dicotyledons, especially vines, tobacco, potatoes and tomatoes, in the absence of any pathogenic agent, thus conferring immunization on the plants.

4. A method for the stimulation and potentiation of natural plant defenses, especially the natural defenses of monocotyledons, and in particular of cereals, including more particularly wheat, and of dicotyledons, especially of vines, tobacco, potatoes and tomatoes, characterized in that an effective amount of at least one oligomer having a degree of polymerization of preferably 1 to 30, of xanthan especially in the form of a composition, and in particular of an aqueous solution containing the xanthan oligomer(s) at a concentration of 0.1 mg/l to 50 mg/l, preferably of 0.1 mg/l to 20 mg/l, is applied especially to the leaves or to the seeds or grains and before any attack by a pathogenic agent, the effective amount corresponding to that which is provided to the plants to be treated by applying the abovementioned composition in a proportion of 10 g to 1000 g, preferably of 20 g to 500 g, per hectare of crop.
